(19) United States
(12) Patent Application Publication
(10) Pub. No.: US 2007/0088531 A1
(43) Pub. Date: Apr. 19, 2007

(54) Methods For Generating Digital Or Visual Representations Of A Closed Tessellated Surface Geometry

(76) Inventor: Wei Yuan, HUNTSVILLE, AL (US)

Correspondence Address: WADDEY & PATTERSON, P.C., 1600 DIVISION STREET, SUITE 500, NASHVILLE, TN, 37203, US

(21) Appl. No.: 10/596,553

(22) PCT Filed: Dec. 20, 2004
(86) PCT No.: PCT/US04/42910

§ 371 Date: Jun. 16, 2006

Related U.S. Application Data
(60) Provisional application No. 60/531,380, filed on Dec. 19, 2003.

(51) Int. Cl. G06F 17/10

(52) U.S. Cl. 703/2

(57) ABSTRACT

The present invention is a method that creates perfectly closed tessellated surface geometries suitable for application in mesh generation, engineering and mathematical analysis, visualization, and animation.

### BACKGROUND ART

The present invention relates generally to geometric computer modeling and, in particular, to computer and engineering applications which require closed (watertight) surface geometry models.

A common way of representing the geometry of a mechanical or biological object is to describe its surface boundary. A curved surface boundary can be described by a set of piecewise linear patches, i.e., triangles, quadrilaterals, or any arbitrary polygons. A congruent arrangement of a set of polygons to define a surface area is sometimes referred to as a tessellation. Any polygon of four or higher vertices can be represented by a set of triangles which represent the same surface area. Therefore, it is sufficient to assume that any curved geometric model can be represented by a set of triangles. The greater the number of triangles that are used to represent a curved surface area, the more accurate the approximation of that surface area will be.

A tessellation or triangulation of a geometric model is said to be proper, closed, or watertight if each side of each triangle is exactly shared with one (and only one) other triangle. In case of open surface geometries, a tessellation is one in which each side (edge) of each interior triangle is exactly shared with one (and only one) other triangle while those triangles along the boundary of the geometry may have one or two sides (edges) that are not shared with another triangle.

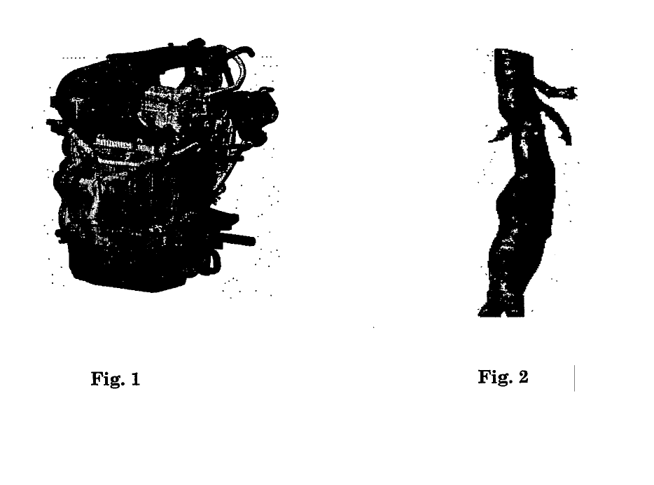

Triangulated surface geometries are commonly used in many industrial applications, including automotive engineering (FIG. 1), biomedical engineering (FIG. 2), and in visualization/animation. For mechanical computer-aided design (CAD) applications, the triangulated surface geometry is often generated within the CAD system. A major industrial application of triangulated surface geometries is in rapid prototyping or stereo-lithography, which allows an engineer to create solid, plastic, three-dimensional (3-D) objects from CAD drawings in a matter of hours. More recently, stereo-lithography files (STL) have been used for computer aided engineering (CAE) applications. FIG. 1 is a visual representation of a triangulated surface model of an internal combustion engine as defined by an STL file. On the other hand, for biomedical applications the triangulated surface geometry is generally obtained by reconstructing the three dimensional surface area from a set of two-dimensional cross-sections typically obtained from magnetic resonance imaging (MRI) or other types of scanners. FIG. 2 is a visual representation of a triangulated surface model of a section of human tissue as defined by an STL file.

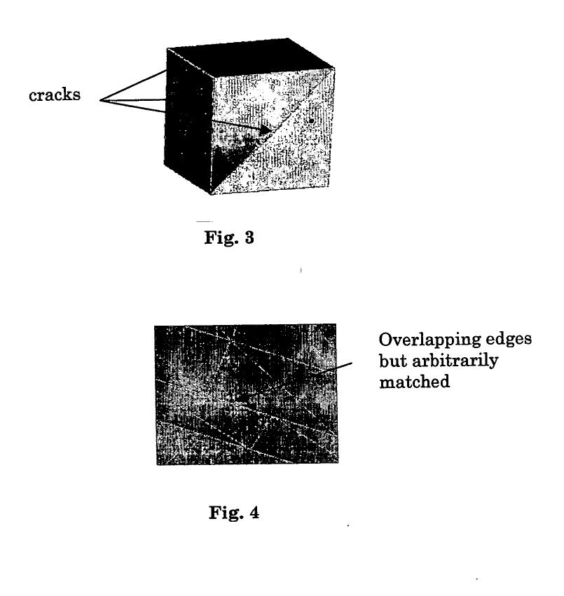

For CAE applications, a triangulated surface geometry may be used twofold: (a) to generate a computational volumetric mesh for the geometry/solid model; or (b) may be used directly by certain flow solvers. For each of these, an important requirement is that the surface triangulation is closed or watertight. However, in many instances the triangulation is not proper. For example, a tessellation generated using conventional methods may have: (a) cracks between triangles, as illustrated in FIG. 3, (b) dangling triangles; (c) overlapping triangles; or (d) arbitrarily matched triangles, as shown in FIG. 4. These inaccuracies seriously limit the usefulness of the tessellated surface representation.

What is needed, then, is a method of accurately generating digital or visual representations of a closed tessellated surface geometry.

### DISCLOSURE OF THE INVENTION

This invention provides methods for creating closed, watertight, tessellated surface geometries such that all surface elements are one-to-one connected to each other. The surface geometries define models of industrial or biomedical components that can be displayed and digitized. In one embodiment of the method, an arbitrary geometry or surface tessellation is used as an input to produce a proper surface tessellation as an output, which may be used for subsequent processing for CAE applications. One embodiment of the method can be summarized as a sequence of processing steps substantially as follows:
1. Import a geometric model from a CAD system, scanner, etc.;
2. Generate a 3-D volume mesh around the model;
3. Identify closed mesh fronts that enclose the model;
4. Map closed mesh fronts onto the model; and
5. Optimize the mesh quality.
   Optionally, the closed geometry surface model can be exported for engineering applications.

The method is preferably implemented as a computer program, such as fluid dynamic simulation software.

Thus, one object of the method of the present invention is to generate closed surface geometries from arbitrary surface geometries. The method provides several distinct advantages for computer automated engineering (CAE) applications:
1. An accurate closed (watertight) surface model is generated.
2. A smooth, high quality surface mesh is obtained.
3. The method can handle multiple intersecting models.

FIG. 1 is a visual representation of a triangulated surface model of an internal combustion engine as defined by an STL file.

FIG. 2 is a visual representation of a triangulated surface model of a section of blood vessel as defined by an STL file.

FIG. 3 illustrates an example of surface cracks in a tessellated surface representation generated using prior art methods.

FIG. 4 illustrates an example of overlapping edges in a tessellated surface representation generated using prior art methods.

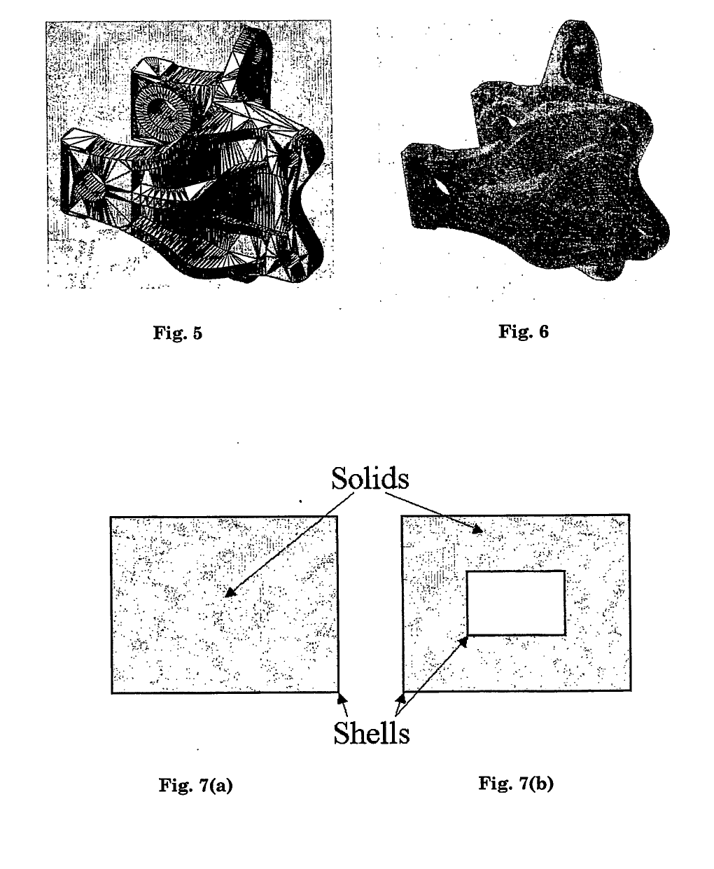

FIG. 5 is a visual display representation of an original surface geometry of a mechanical component.

FIG. 6 is a visual display of the resulting closed tessellation of the original surface geometry of FIG. 5, using the method of the present invention.

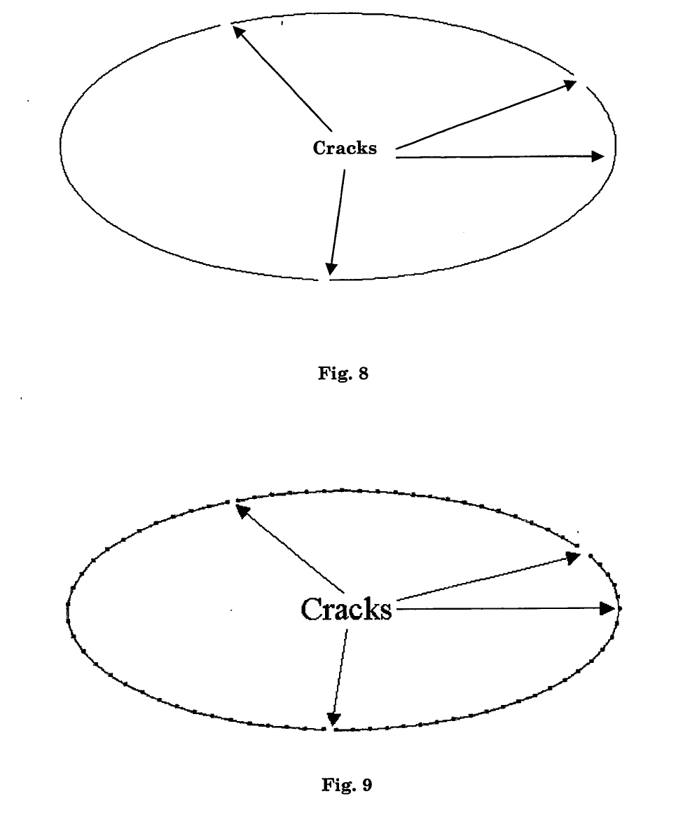

FIG. 7(a) is a representation of a 2-D solid consisting of a single shell.

FIG. 7(b) is a representation of a 2-D solid consisting of two shells.

FIG. 8 is a non-discrete representation of a two dimensional geometry containing four cracks.

FIG. 9 is a discrete representation of the geometry represented in FIG. 8.

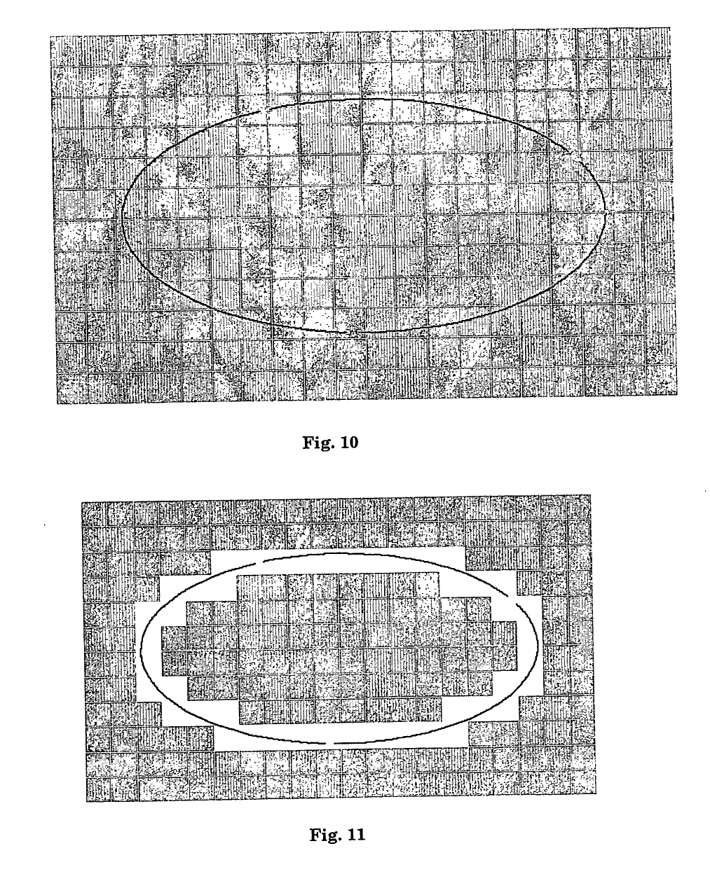

FIG. 10 illustrates a volume mesh inside a bounding box that encloses the geometry, as generated in accordance with the method of the present invention. The end points of the geometric curves are shown to highlight the cracks in the geometry.

FIG. 11 shows the volume mesh of FIG. 10 after cells intersecting the geometry are identified and discarded in accordance with the method of the invention.

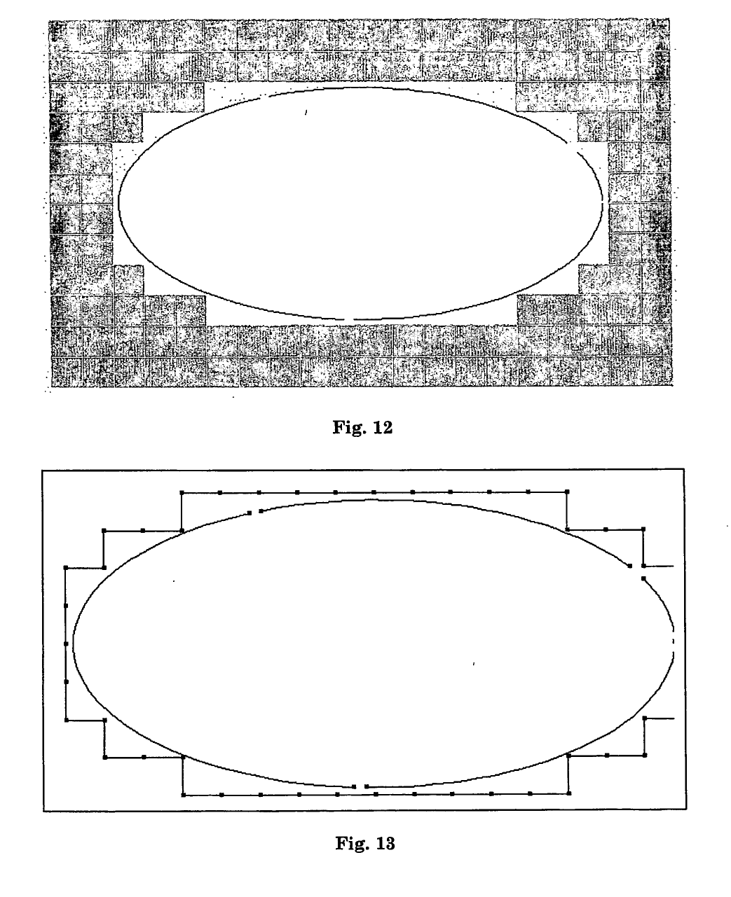

FIG. 12 shows the volume mesh of FIG. 11 after the interior cells are identified and discarded in accordance with the method of the invention.

FIG. 13 shows the mesh front derived from the volume mesh of FIG. 12 after front faces are extracted from the interior boundaries of the volume mesh in accordance with the method of the invention. The front faces form a watertight mesh and lie outside the geometry.

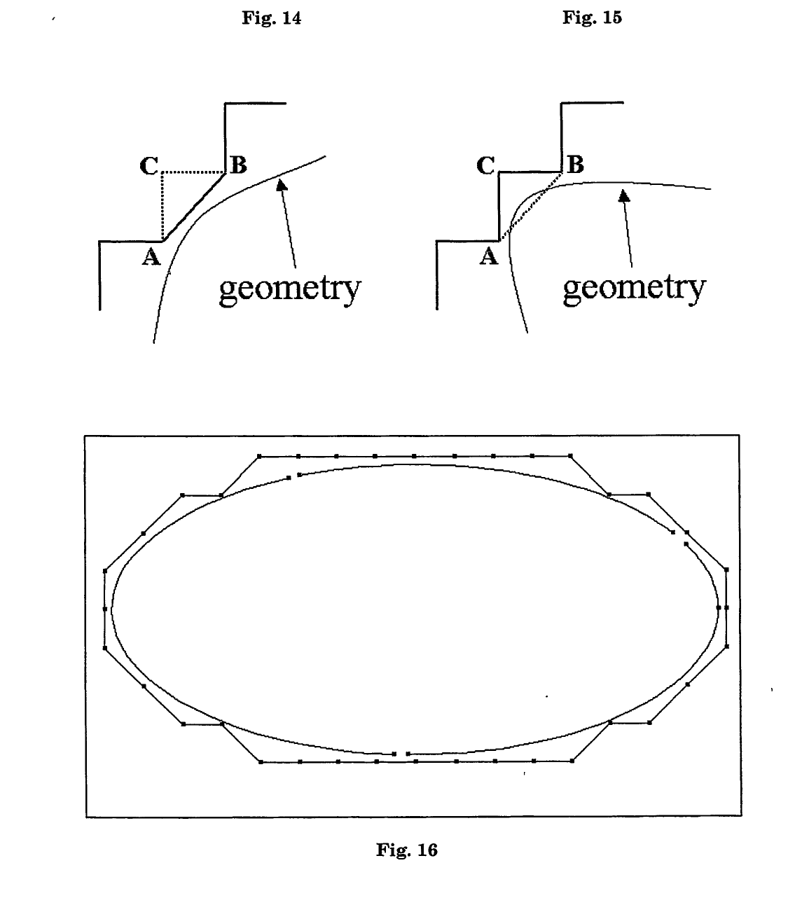

FIG. 14 illustrates the replacement of a “sharp corner” ACB with a face AB that does not intersect the geometry, in accordance with one embodiment of the present invention.

FIG. 15 shows a sharp corner ACB that cannot be eliminated because it would result in a face AB that intersects with the front of the geometry.

FIG. 16 shows the mesh front of FIG. 13 after elimination of “sharp corners” in accordance with the method of the invention.

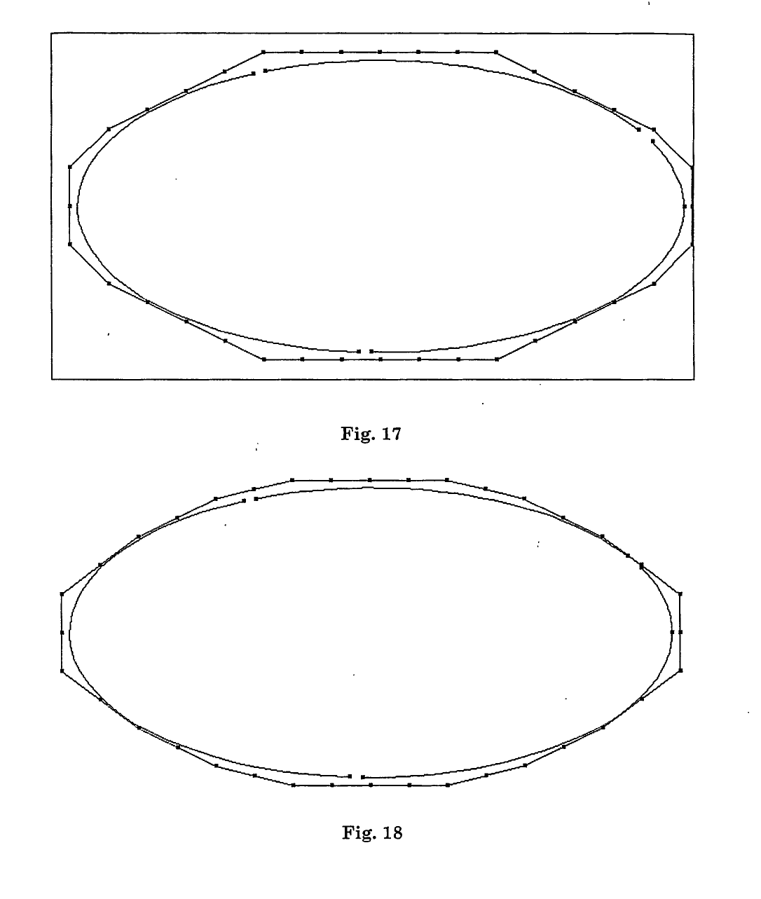

FIG. 17 shows the mesh front of FIG. 16 after one smoothing pass in accordance with the method of the invention.

FIG. 18 shows the mesh front of FIGS. 16 and 17 after a second smoothing pass.

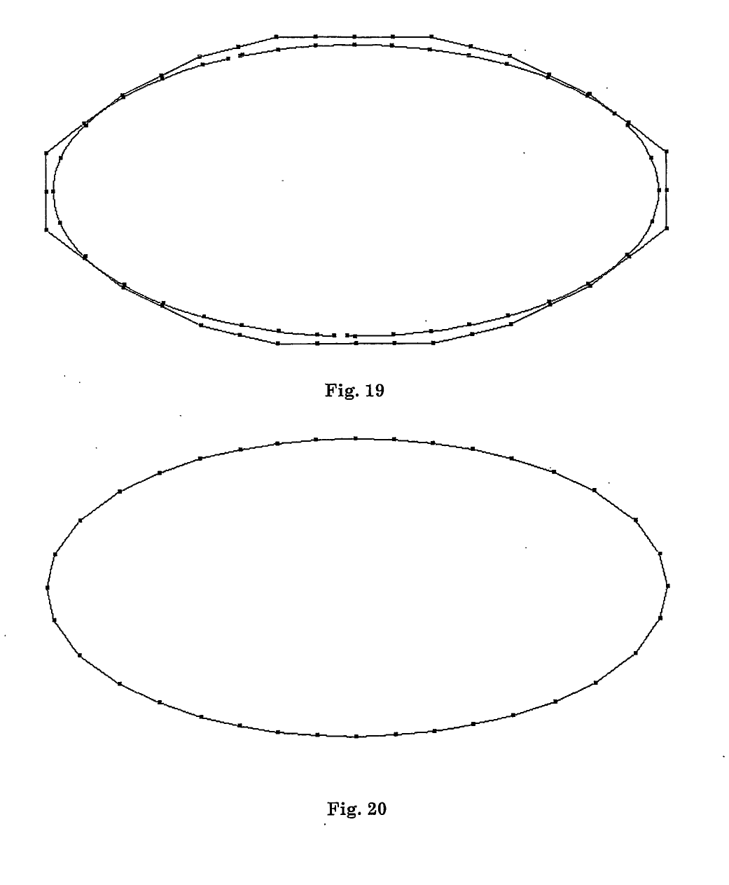

FIG. 19 shows projected vertices on the original geometry, in accordance with the method of the invention.

FIG. 20 illustrates the closed mesh front after projection onto the geometry.

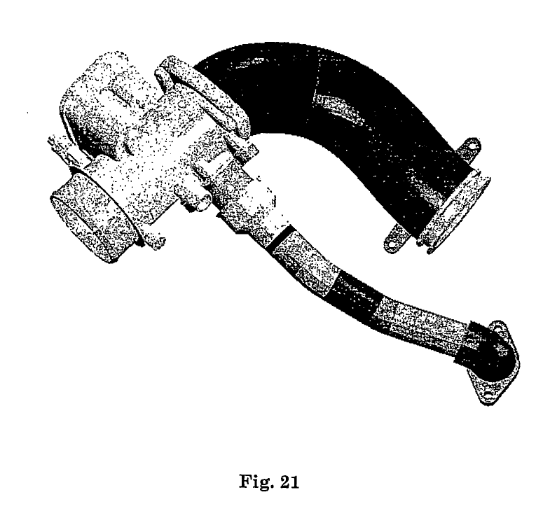

FIG. 21 illustrates an example of a three dimensional geometric model of an automotive component assembly that can be imported for further processing in accordance with the method of the present invention.

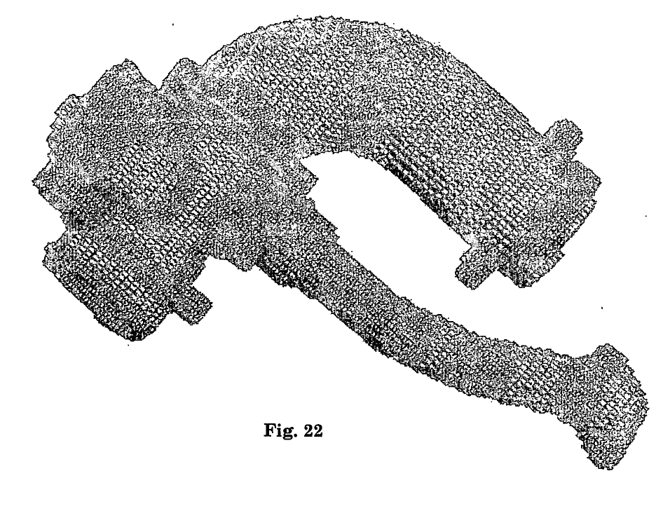

FIG. 22 shows a closed front generated around the geometry shown in FIG. 21, in accordance with the method of the present invention.

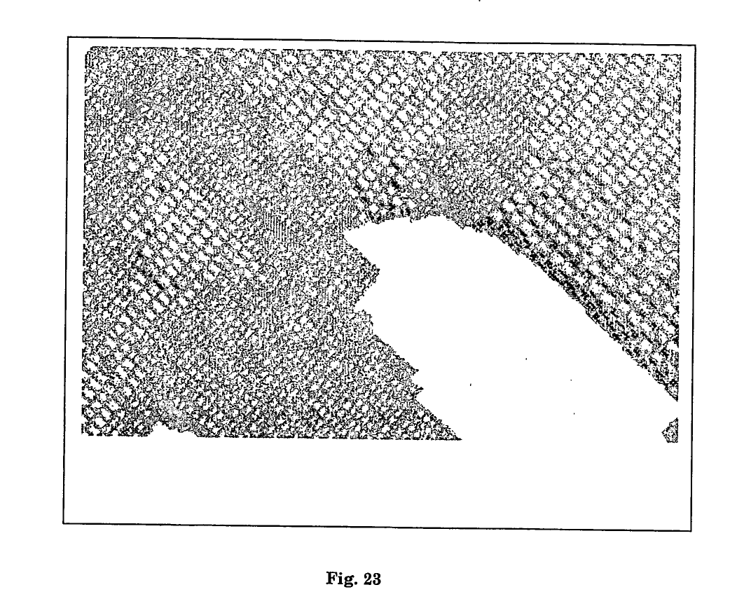

FIG. 23 is an enlarged view of a portion of the front shown in FIG. 22.

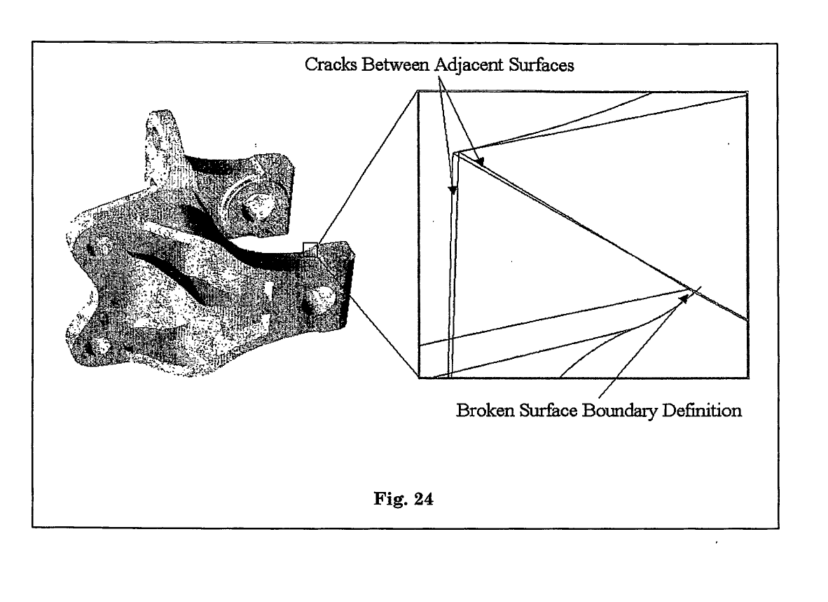

FIG. 24 illustrates a non-discrete part with a segment of the surface geometry containing cracks and broken surface boundary definitions.

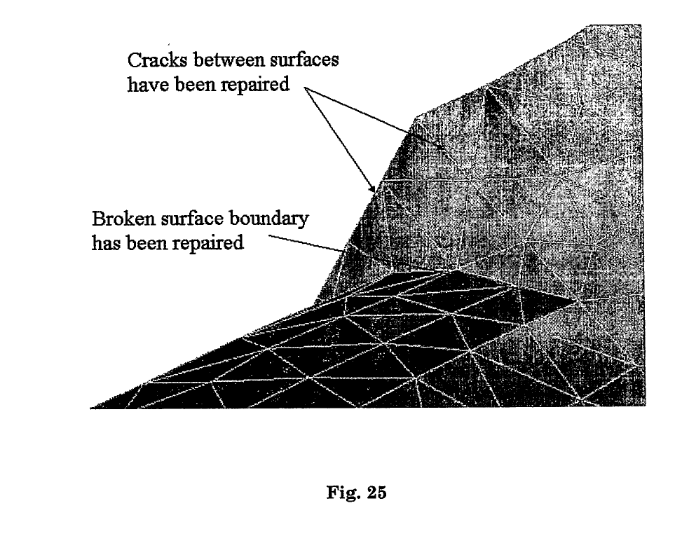

FIG. 25 shows a watertight tessellation of the geometry shown in FIG. 24, as generated using the method of the present invention. The view has been rotated slightly to show how curvature in the region was captured.

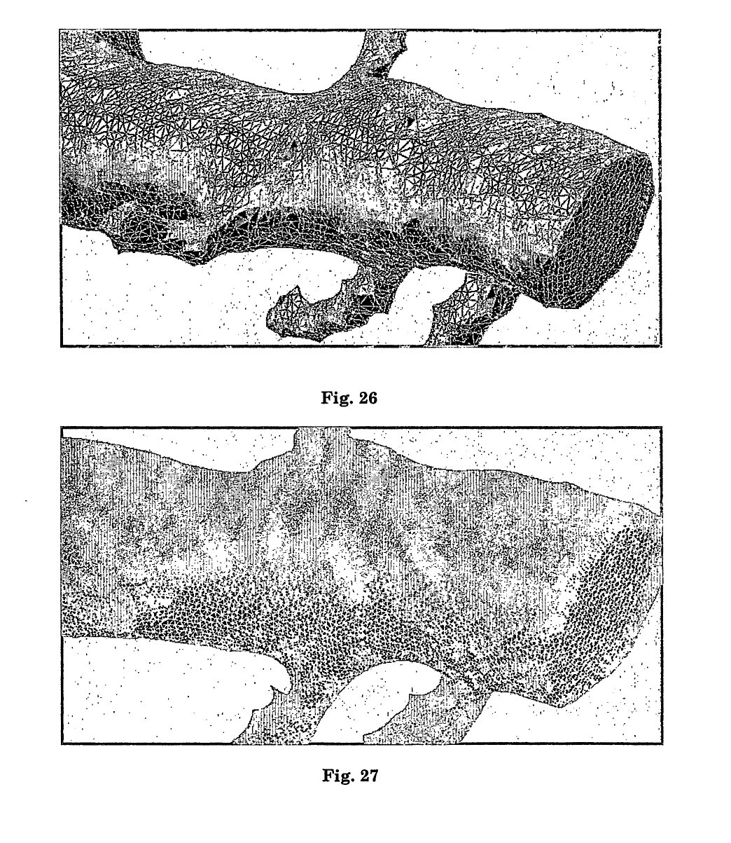

FIG. 26 is a visual representation of a discrete model of a blood vessel showing overlapping and poor quality faces prior to application of the method of the present invention.

FIG. 27 shows a shrink wrap mesh around the model in FIG. 26 in accordance with the method of the present invention.

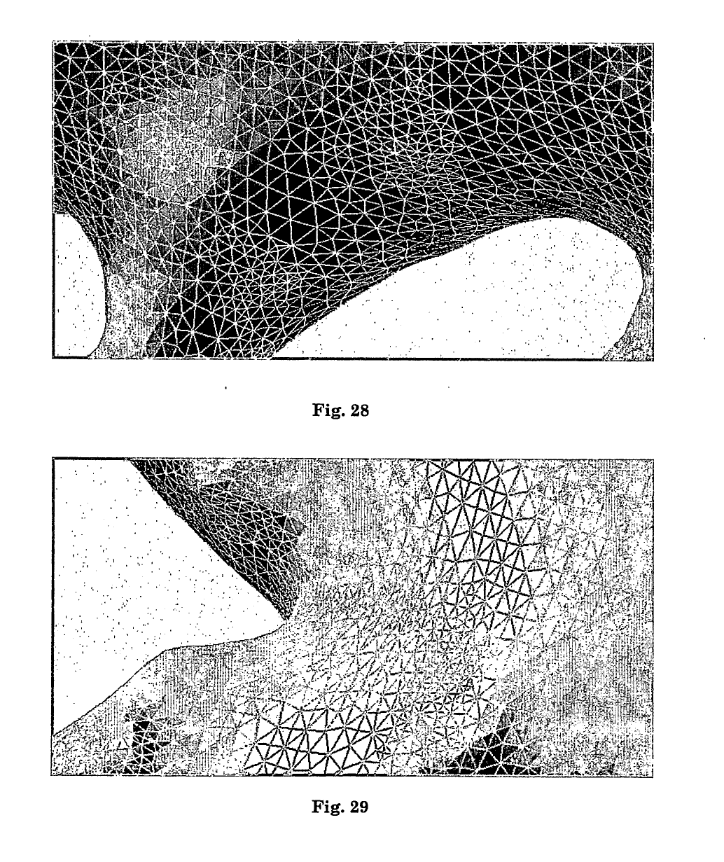

FIG. 28 is a close-up of a portion of the mesh shown in FIG. 27.

FIG. 29 is a close-up of the portion of the mesh shown in FIG. 27.

### BEST MODE FOR CARRYING OUT THE INVENTION

The methods of the present invention are described below for two-dimensional (2-D) and three-dimensional (3-D) geometries. This section will define some of the terminology used in those descriptions as they relate to modeling and meshing.

Numerous computer modeling terms are used by CAD vendors and researchers, including many different definitions of those terms. The terms most relevant to the description of the methods of this invention are shell and solid. For purposes of the methods of this invention, a 2-D shell is a logically closed planar collection of curves. A 3-D shell is defined to be a logically closed collection of surfaces. In both cases, the shells, though logically closed, are not necessarily mathematically watertight. Shells divide the universe into two portions—the portion existing outside of the shell, and the portion that is inside the shell. A solid is a collection of one or more shells of the same dimensionality. For solids consisting of a single shell the solid is that portion of space that lies inside the shell. A 2-D solid represented by a single shell is illustrated in FIG. 7(a). For solids consisting of two or more shells, one of the shells will typically fully enclose the others. Such solids define the space between the outer and inner shells. This allows solids to contain voids. FIG. 7(b) shows a 2-D solid consisting of two shells where the smaller shell defines a void and the inner boundary of the solid. In each of the solids shown in FIGS. 7(a) and 7(b), each shell includes four curves. In the field of the present invention, solids are often referred to as parts, and these terms are used interchangeably herein.

In typical applications of the methods of this invention, the user is interested only in generating a mesh around the outermost shell (i.e., the outer geometric boundary) of a solid. However, this is not a restriction on the use of the methods. For example, in FIG. 7(b), a mesh could be generated on each shell individually for applications that require meshing of both the outer and inner boundaries.

Mathematically, shells can be represented in two ways—discretely and non-discretely. In non-discrete representations, the underlying curves or surfaces are defined exactly via analytical or spline representations. In addition, the representations of surfaces may be further refined through the use of trimming curves. In discrete representations, the underlying curves or surfaces are approximated via a mesh. In 2-D, curves are represented by collections of line segments. In 3-D, surfaces are represented by n-sided polygons where n is at least 3. A shell may consist of discrete and non-discrete components simultaneously. FIGS. 8 and 9 illustrate examples of a 2-D shell represented non-discretely and discretely.

Shells, and consequently the parts derived from them, are not necessarily watertight. For purposes of the present invention, shells with certain properties are considered to be non-watertight. For 2-D shells, a shell is considered to be non-watertight if gaps exist between logically adjacent curves, if internal gaps exist in curves with discrete representations, and/or if adjacent curves overlap. A 3-D shell is considered non-watertight if gaps exist between logically adjacent surfaces, if internal holes exist in a surface definition, and/or if adjacent surfaces overlap. For simplicity in explanation of the method of the present invention, solids or parts are referred to as entities built from a single shell that may exhibit the problem characteristics listed above.

For purposes of facilitating an understanding of the methods of the invention, mathematical terms used in meshing are defined as follows:
Vertex—a point in 2-D or 3-D space.
Edge—a line segment bounded by two distinct vertices.
Triangle—a closed collection of three distinct edges.
Quadrilateral (quad)—a closed collection of four distinct edges.
Arbitrary Polygon—a closed collection of five or more distinct edges.
Tetrahedron—a closed collection of four distinct triangles.
Pyramid—a closed five-vertex element consisting of one quadrilateral and four distinct triangles.
Prism or Wedge—a closed six-vertex element consisting of two distinct triangles connected by three distinct quads.
Hexahedron—a closed eight-vertex element consisting of six distinct quads.
Arbitrary Polyhedron—a closed collection of any number of distinct triangles, quads, and/or arbitrary polygons.

For 2-D mesh generation, a “face” is an edge and a “cell” is a planar triangle, quad, or arbitrary polygon. For 3-D mesh generation, a “face” is a triangle, quad, or arbitrary polygon (in which the quads and arbitrary polygons are not necessarily planar) and a “cell” is a tetrahedron, pyramid, prism, hexahedron, or arbitrary polyhedron.

One of the final products of use of the method is a mesh consisting of one or more closed, watertight collections of faces. In 2-D, such a mesh is considered to be watertight if every face has exactly one neighboring face connected to each of its bounding vertices, and if every vertex bounds exactly two faces. In 3-D, a mesh is considered to be watertight if every face has exactly one neighboring face opposite each of its bounding edges, and if every edge bounds exactly two faces.

A Cartesian mesh in 2-D and 3-D refers to a spatial decomposition of an area or volume along lines of constant X, Y, and Z. In 2-D, the basic mesh element is a quad (or rectangle, square) and in 3-D the basic mesh element is a hexahedron (or box, cube).

The general method of the invention can be applied to two-dimensional and three-dimensional models, yielding 2-D and 3-D closed model representations, respectively. Because the 2-D method is easier to visualize, the application to 2-D mesh generation is presented first. A method for 3-D models is discussed below.

The steps of the general method of the invention include:
1. Model import
2. Volumetric mesh generation
3. Closed Front extraction
4. Front mapping to geometry
5. Mesh Optimization
   Step 1: Model Import

In one embodiment of the method, a first step is to import into a model processor the model upon which a closed model tessellation is to be created. There are two basic types of models that can be imported—discrete and non-discrete models. For the purposes of 2-D shrink wrapping, a non-discrete model will include lines and curves that are defined analytically and/or via splines, as shown in FIG. 8. In a discrete representation, a geometry is approximated by a set of line segments only, as shown in FIG. 9. The discrete and non-discrete models that are imported are not required to be watertight.

In the representations of FIGS. 8 and 9, one of the cracks is invisible to the naked eye. In addition, this method can be used for (partially) overlapping geometries and/or any combination with cracks.

In one embodiment of the invention, the model is imported into a model processor, such as a combination of computer hardware and software that is capable of interpreting, storing, processing, and manipulating data in a computer-readable file that defines the model.

Step 2: Volumetric Mesh Generation

In a second step, a bounding box is generated around the geometry. This process can be automated by examining the minimum and maximum extents of the geometry. To simplify volume mesh generation, the bounding box is made somewhat larger than the geometry. The bounding box is then filled with a volume mesh. This mesh may be defined by any 2-D cell type, including triangles, quadrilaterals, or arbitrary polygons. FIG. 10 shows a bounding box filled with a uniform quadrilateral mesh. In a preferred embodiment, the meshing algorithm has the following capabilities:
User-controllable global mesh density.
User-controllable local mesh density around features of interest.
Automatic refinement around small features and regions of high curvature.

These capabilities can help the method tailor its results to the needs of target applications. Numerous 2-D volume meshing methods, well-known to those of skill in the art, may be used. In some applications, 2-D Cartesian (quadtree) meshes best satisfy the requirements and offer the best performance. To simplify further discussion, the remaining examples will be based upon a Cartesian volume mesh consisting only of quads.

Step 3: Closed Front Extraction

An important aspect of the method of the present invention is the creation and identification (extraction) of a closed front around the geometry of the model. In the 2-D method, a closed front consists of one or more closed collections of faces. The number of these collections depends upon the number of parts in the model and their relationships to each other. In this step, front extraction is performed in the following 3 stages.
Discard all cells intersecting the geometry.
Discard all remaining cells that lie inside the geometry.
Extract front faces from interior boundaries of the remaining volumetric mesh.

As part of this step, it is preferred that all cells intersecting with the geometry are identified and discarded. This will divide the domain into one collection of cells lying completely outside the geometry and one or more collections of cells lying inside the geometry. The number of collections of the latter type will depend upon the characteristics of the geometry. As seen in FIG. 11, the example geometry yields one collection of inner cells.

All collection(s) of cells lying in the geometry interior are discarded, as shown in FIG. 12. Alternatively, the exterior cells can be discarded while keeping the interior cells. However, because of the mathematical behavior of the smoothing algorithms used in subsequent steps, the current approach significantly improves the robustness of the method and yields higher quality meshes.

In this third step, one or more holes are cut in the volumetric mesh, with each hole completely enclosing a geometry “part.” FIG. 12 shows one hole enclosing one part. Now the boundaries of the hole(s) are identified and grouped into closed collection(s) of faces. These collections of faces are referred to as fronts. FIG. 13 shows the mesh front derived from the volume mesh shown in FIG. 12.

Step 4: Mapping Front to Geometry

In the first three steps, a front has been generated around the geometry. This front consists of a watertight mesh that has the same general shape as the geometry. However, these meshes have three potential problems. First, the vertices in the mesh may not lie on the geometry. Second, the mesh may not adequately capture curvature in the geometry. Third, sharp corners in the mesh may introduce artificial curvature not present in the geometry.

To support applications requiring meshes that approximate geometries with a higher degree of fidelity, the method of this invention includes steps to map the initial front mesh onto the geometry. Because the current front mesh is already closed, the steps taken during the mapping process are such that the front remains closed. The mapping process includes two stages that more closely align the front mesh with the geometry. It also includes a third stage in which the mesh is projected onto the geometry. These stages are described below.

First, sharp corners are eliminated from the mesh front. The definition of “sharp corner” depends upon the type of volume mesh generated in the prior step, and can also vary among implementations of the “shrink wrap” meshing algorithm. In general, sharp corner removal brings the mesh front closer to the geometry without actually moving vertices (though vertices may be removed). For example, a sharp corner can be a concave region (as viewed from the geometry in the vicinity) defined by two grid faces (i.e. line segments) that are nearly orthogonal to each other. FIGS. 14 and 15 show two such grid faces AC and BC, with C being a vertex shared by the two faces. The two grid faces are replaced with a single grid face AB. The only hard restriction on this operation is that the new grid face must not intersect the geometry. It may also be desirable to avoid corner removals that yield faces that are large with respect to their neighbors. FIG. 16 shows the mesh front after elimination of sharp corners.

After sharp corners have been eliminated, the next stage involves smoothing of the mesh front. Until now, all mesh vertices have remained at the locations that they occupied within the volume mesh. In this stage, they are moved to locations that bring the mesh front into closer alignment with the geometry. Those of skill in the art will recognize that numerous sophisticated smoothing techniques are available. In the embodiment of the invention discussed here, a simple Laplacian smoother is sufficient. A mesh vertex is relocated such that its new coordinate values are equal to the average of the coordinates of its neighboring vertices. However, movement of a vertex is rejected if the movement causes the mesh front to intersect the geometry or if the movement causes the vertex to move further away from the geometry.

Several smoothing passes are performed until a specified cutoff criterion is met. With each smoothing pass, the front mesh becomes more closely aligned with the geometry. A side effect of using Laplacian smoothing (and many other smoothing algorithms), coupled with the above restrictions, is that the mesh vertices tend to move closer to the geometry (i.e. the mesh front shrinks).

FIG. 17 shows the mesh front after a first smoothing pass. FIG. 18 shows the mesh front after a second smoothing pass. This step in no way alters mesh connectivity. Accordingly, the front mesh cannot become non-watertight.

Each smoothing pass tends to pull the front mesh closer to the geometry. However, performing a large number of smoothing steps will often be computationally prohibitive. Moreover, for many types of geometries, this approach may not adequately shrink the front mesh onto the geometry. This is particularly true in geometries containing concave regions (as viewed from outside the geometry). To circumvent these two problems, a final mapping step is performed. This final mapping step involves projection of the mesh vertices directly onto the geometry. In this step, each mesh vertex is moved (via a closest-point projection) onto the geometry. Using a closest-point projection guarantees that mesh vertices do not project into gaps in the geometry. FIG. 19 shows the mesh vertices and the locations to which they will project on the example geometry.

In some cases, vertex projection may be rejected. For example, if a vertex projection would result in two adjacent grid faces where one is very large with respect to the other, the vertex is not moved. This situation can occur when a vertex is located near the middle of a sufficiently large gap in the geometry. The connectivity of the front mesh is not altered and the mesh always remains watertight. FIG. 20 shows the result of the projection onto the example geometry.

Step 5: Mesh Repair/Optimization

In some cases, the final front mesh, though watertight, may require some repair and/or optimization before it can be used in applications. In some complex 2-D models, the projection may produce some folded or overlapping faces. These are typically unacceptable to target applications and, therefore, are repaired in the current method. Additionally, some mesh smoothing is often helpful when target applications are sensitive to mesh quality. Several techniques are available for performing mesh repair and optimization. In 2-D cases, these options include (but are not limited to) vertex smoothing, with a subsequent re-projection to the geometry and face combining, where, for example, a very small face is combined with an adjacent face that is much larger. Regardless of the choices made at this point in the method, the steps are performed in such a way that the mesh always remains closed and that the steps do not cause the shape of the mesh to deviate from that of the geometry beyond acceptable limits.

The method of the present invention as used in 3-D follows the same steps as in 2-D, with each step tailored for 3-D geometries and meshes. These steps are briefly described below:

Step 1: Model Import

As in 2-D, a model must be imported. Such models can be generated by CAD systems, scanners, and the like. 3-D models may have discrete or non-discrete representations. Non-discrete models will typically have trimmed analytic or spline surfaces that, collectively, may or may not form watertight components. Discrete models may consist of triangles, quadrilaterals, or arbitrary polygons that, collectively, do not necessarily form watertight components. FIG. 21 shows an example 3-D model geometry that may be imported.

Step 2: Volume Mesh Generation

In a second step, a 3-D bounding box is generated around the geometry and filled with a volume mesh. The volume mesh may consist of any combination of 3-D cell types, including tetrahedra, pyramids, wedges (prisms), hexahedra, and arbitrary polyhedra. In practice, 3-D Cartesian meshing (octree or omnitree) produces volume meshes most suitable as input to subsequent steps. In the remaining discussion of the 3-D method, it is assumed that an octree mesh has been generated.

Step 3: Closed Front Extraction

As in the 2-D method, a closed front surrounding (but not intersecting) the geometry is extracted from the volume mesh. All cells intersecting the geometry or lying in the geometry interior are identified and discarded. The resulting front faces (depending upon the volume mesh type) may consist of triangles, quadrilaterals, and/or arbitrary polygons. FIG. 22 shows a closed front (viewed from the outside) generated around the geometry in FIG. 21. FIG. 23 is an enlarged view of a portion of the closed front illustrated in FIG. 2.

While not strictly necessary, polygonal front faces (if present) may be split into triangles and/or quadrilaterals. Performing this additional step eliminates problems associated with mapping faces with five or more sides onto the geometry. It also significantly simplifies certain calculations performed during that step.

Step 4: Mapping Front to Geometry

In a next step, the closed front is mapped to the geometry. As in 2-D, sharp corners are removed and smoothing is performed. By their very nature, these operations are much more complex in 3-D than in 2-D. However, the end result is always a closed front more closely aligned with the geometry, and that is located more closely to the geometry in most regions. Finally, the mesh vertices are projected onto the geometry. Throughout this mapping process, the watertight nature of the mesh front is preserved.

Step 5: Mesh Repair/Optimization

In 3-D cases, mesh repair/optimization steps are more prominent in the shrink wrapping process than in 2-D. This is because, given the complexity of the 3-D mesh mapping process, some overlapping and/or skewed faces may be produced. Again, a combination of smoothing/re-projection and face merging is used to eliminate these problems. Additionally, other steps such as edge-swapping, vertex insertion, vertex removal, and degenerate face removal are also available and used in 3-D for improving mesh quality and for mesh repair.

As in the 2-D method, these steps guarantee that the mesh remains closed and that they do not cause the shape of the mesh to deviate from that of the geometry beyond acceptable limits.

Depending upon the implementation of the method, a closed watertight surface tessellation may contain triangles, quadrilaterals, and arbitrary polygons. Depending on the needs of the target application, quadrilaterals may be reduced to triangles, and arbitrary polygons may be reduced to triangles and/or quadrilaterals.

Before and after examples of use of the method of the invention for a 3-D geometry are shown in FIGS. 24 through 30. A 3-D model of a non-discrete part containing cracks and broken boundary definitions is shown in FIG. 24. FIG. 25 shows a watertight tessellation of the geometry of FIG. 24, with cracks and broken surface boundaries repaired in accordance with the method of the invention.

FIG. 26 shows a discrete geometric model of a blood vessel having overlapping faces and faces of very poor quality. Such a model is unsuitable for most target applications. However, FIG. 27 shows a “shrink wrap” mesh around the model of FIG. 26, generated in accordance with the method of the present invention. FIGS. 28 and 29 are close-up views of the shrink wrap mesh of FIG. 27.

FIG. 5 is a visual display representation of an original surface geometry of a mechanical component. FIG. 6 is a visual display of the resulting closed tessellation of the original surface geometry of FIG. 5, using the 3-D method of the present invention as described above.

It will now be understood by those skilled in the art that the method of the present invention uses a unique indirect (inverse) approach in the sense that a volumetric mesh is used to obtain a closed tessellated surface representation. The initial front is closed and proper (watertight), because it is extracted from the volumetric mesh around the geometry. Each subsequent step for mapping and optimization also ensures that the front remains closed and proper (watertight). Therefore, the final tessellated surface representation is guaranteed to be closed and proper (watertight).

The present method works for arbitrarily complex geometries in two and three dimensional space. The method also works for geometries with imperfections, such as cracks between patches, overlapping patches, dangling patches, and arbitrarily matched patches.

The steps of the method of the present invention can be implemented in computer software, with the particular programming language selected in accordance with the preferences of the user. For example, the methods of the invention can be performed using fluid dynamic simulation software for generating (in a computer) a visual or digital representation of a model having a closed tessellated surface geometry. Such software will preferably include one or more modules containing sets of instructions that are coded to perform the steps as described above. These modules or sets of instructions may be discrete or combined, again in accordance with the preferences of the user. For example, in one embodiment, the software will include a first set of instructions functional to import a geometric model into a model processor operatively associated with the computer, a second set of instructions functional to generate a volume mesh around the imported geometric model, a third set of instructions functional to extract a first mesh front that encloses the model, the first mesh front comprising a closed mesh that generally conforms to geometry of the model, a fourth set of instructions functional to map the first mesh front onto the model geometry; and a fifth set of instructions functional to optimize the first mesh front. Optionally, the software will further include a sixth set of instructions functional to export the model from the computer. The actual coding of the software from the disclosure of the methods contained herein is conventional and is a routine task for a person of ordinary skill in the art.

The exportation of the model, now having a closed tessellated surface geometry, can be in the form of generating a visual representation of the model on a display device or printer connected to a computer, or exporting a computer readable file of the model for use by a another computer, by a CAD system, by a stereo-lithography system, another software application, and the like.

Thus, although there have been described particular embodiments of the present invention of a new and useful Methods for Generating Digital or Visual Representations of a Closed Tessellated Surface Geometry, it is not intended that such references be construed as limitations upon the scope of this invention except as set forth in the following claims.

What is claimed is:

1. A method for generating a digital or visual representation of a closed tessellated surface geometry comprising the steps of:
a. importing a geometric model into a model processor, the model having a geometry defining a shape of the model;
b. generating a volume mesh around the imported geometric model;
c. extracting a first mesh front that encloses the model, the first mesh front comprising a closed mesh that generally conforms to geometry of the model;
d. mapping the first mesh front onto the model geometry; and
e. optimizing the first mesh front, thereby creating a digital representation of a closed tessellated surface geometry.

2. The method of claim 1 further comprising the step of exporting the model from the model processor.

3. The method of claim 2 where the model is exported for a visual representation on a display screen.

4. The method of claim 1 wherein the geometric model comprises a 2-D model.

5. The method of claim 4 wherein the volume mesh comprises a plurality of 2-D cells.

6. The method of claim 5 wherein the step of generating a volume mesh comprises generating a 2-D bounding box around the geometry and then filling the bounding box with a volume mesh.

7. The method of claim 5 wherein the volume mesh is a 2-D Cartesian mesh.

8. The method of claim 6 wherein the first mesh front comprises at least one collection of a plurality of faces.

9. The method of claim 5 wherein the step of extracting a first mesh front includes
identifying and discarding all cells that intersect the geometry of the model, thereby defining a first collection of cells positioned inside the geometry and a second collection of cells positioned outside the geometry,
discarding one of the first or the second collection of cells, thereby defining at least one hole in the volume mesh, the hole enclosing a part in the geometric model, and
identifying hole boundaries associated with the hole and grouping the hole boundaries into a collection of faces, the collection of faces defining a mesh front.

10. The method of claim 9 wherein the step of mapping the mesh front onto the model geometry comprises
eliminating sharp corners from the mesh front, and
smoothing the mesh front.

11. The method of claim 10 wherein the step of mapping the mesh front onto the model geometry further comprises projecting mesh vertices directly onto the geometry.

12. The method of claim 11 wherein the step of optimizing the mesh front includes smoothing the vertices and re-projecting the vertices onto the geometry.

13. The method of claim 10 wherein the step of optimizing the mesh front includes combining faces.

14. The method of claim 1 wherein the geometric model comprises a 3-D model.

15. The method of claim 14 wherein the volume mesh comprises a plurality of 3-D cells.

16. The method of claim 14 wherein the step of generating a volume mesh comprises generating a 3-D bounding box around the geometry and then filling the bounding box with a volume mesh.

17. The method of claim 16 wherein the volume mesh is a 3-D Cartesian mesh.

18. The method of claim 14 wherein the first mesh front comprises at least one collection of a plurality of faces.

19. The method of claim 15 wherein the step of extracting a first mesh front includes
identifying and discarding all cells that intersect the geometry of the model, thereby defining a first collection of cells positioned inside the geometry and a second collection of cells positioned outside the geometry,
discarding one of the first or the second collection of cells, thereby defining at least one hole in the volume mesh, the hole enclosing a part in the geometric model, and
identifying hole boundaries associated with the hole and grouping the hole boundaries into a collection of faces, the collection of faces defining a mesh front.

20. The method of claim 19 wherein the step of extracting a first mesh front further comprises identifying polygonal front faces and splitting the polygonal front faces into triangular or quadrilateral front faces.

21. The method of claim 19 wherein the step of mapping the mesh front onto the model geometry comprises
eliminating sharp corners from the mesh front, and
smoothing the mesh front.

22. The method of claim 21 wherein the step of mapping the mesh front onto the model geometry further comprises projecting mesh vertices directly onto the geometry.

23. The method of claim 22 wherein the step of optimizing the mesh front includes smoothing the vertices and re-projecting the vertices onto the geometry.

24. The method of claim 22 wherein the step of optimizing the mesh front includes combining faces.

25. The method of either claim 11 or claim 21 wherein the step of smoothing the mesh front comprises multiple smoothing passes.

26. The method of either claim 25 wherein the step of smoothing the mesh front further comprises using a Laplacian smoothing algorithm.

27. The method of claim 26 wherein each smoothing pass comprises projecting each mesh vertex onto the geometry of the model using a closest point projection.

28. Fluid dynamic simulation software for generating in a computer a visual or digital representation of a closed tessellated surface geometry comprising:
a. a first set of instructions functional to import a geometric model into a model processor operatively associated with the computer;
b. a second set of instructions functional to generate a volume mesh around the imported geometric model;
c. a third set of instructions functional to extract a first mesh front that encloses the model, the first mesh front comprising a closed mesh that generally conforms to geometry of the model;
d. a fourth set of instructions functional to map the first mesh front onto the model geometry; and
e. a fifth set of instructions functional to optimize the first mesh front.

29. The software of claim 28 further comprising a sixth set of instructions functional to export the model from the computer.

30. Computer software for generating in a computer a visual or digital representation of a closed tessellated surface geometry comprising:
a. computer code functional to import a geometric model into the computer, the model having a geometry defining a shape of the model;
b. computer code functional to generate a volume mesh around the imported geometric model;
c. computer code functional to extract a first mesh front that encloses the model, the first mesh front comprising a closed mesh that generally conforms to geometry of the model;
d. computer code functional to map the first mesh front onto the model geometry; and
e. computer code functional to optimize the first mesh front, thereby creating a digital representation of a closed tessellated surface geometry.

31. The software of claim 30 further comprising computer code functional to export the model from the computer.

32. The software of claim 31 where the model is exported for a visual representation on a display screen.

33. The software of claim 30 wherein the geometric model comprises a 2-D model.

34. The software of claim 33 wherein the volume mesh comprises a plurality of -2-D cells.

35. The software of claim 34 further comprising computer code functional to generate the volume mesh by generating a 2-D bounding box around the geometry and then fill the bounding box with a volume mesh.

36. The software of claim 34 wherein the volume mesh is a 2-D Cartesian mesh.

37. The software of claim 35 wherein the first mesh front comprises at least one collection of a plurality of faces.

38. The software of claim 34 wherein the computer code that is functional to extract a first mesh front is further functional to
identify and discard all cells that intersect the geometry of the model, thereby defining a first collection of cells positioned inside the geometry and a second collection of cells positioned outside the geometry,
discard one of the first or the second collection of cells, thereby defining at least one hole in the volume mesh, the hole enclosing a part in the geometric model, and
identify hole boundaries associated with the hole and grouping the hole boundaries into a collection of faces, the collection of faces defining a mesh front.

39. The software of claim 38 wherein the computer code that is functional to map the mesh front onto the model geometry is further functional to
eliminate sharp corners from the mesh front, and
smooth the mesh front.

40. The software of claim 39 wherein the computer code that is functional to map the mesh front onto the model geometry is further functional to project mesh vertices directly onto the geometry.

41. The software of claim 40 wherein the computer code that is functional to optimize the mesh front is further functional to smooth the vertices and re-project the vertices onto the geometry.

42. The software of claim 39 wherein computer code that is functional to optimize the mesh front is further functional to combine faces.

43. The software of claim 30 wherein the geometric model comprises a 3-D model.

44. The software of claim 43 wherein the volume mesh comprises a plurality of 3-D cells.

45. The software of claim 43 wherein computer code that is functional to generate a volume mesh is further functional to generate a 3-D bounding box around the geometry and then fill the bounding box with a volume mesh.

46. The software of claim 45 wherein the volume mesh is a 3-D Cartesian mesh.

47. The software of claim 30 wherein the first mesh front comprises at least one collection of a plurality of faces.

48. The software of claim 44 wherein the computer code that is functional to extract a first mesh front is further functional to
identify and discard all cells that intersect the geometry of the model, thereby defining a first collection of cells positioned inside the geometry and a second collection of cells positioned outside the geometry,
discard one of the first or the second collection of cells, thereby defining at least one hole in the volume mesh, the hole enclosing a part in the geometric model, and
identify hole boundaries associated with the hole and grouping the hole boundaries into a collection of faces, the collection of faces defining a mesh front.

49. The software of claim 48 wherein the computer code that is functional to extract a first mesh front is further functional to identify polygonal front faces and split the polygonal front faces into triangular or quadrilateral front faces.

50. The software of claim 48 wherein the computer code that is functional to map the mesh front onto the model geometry is further functional to
eliminate sharp corners from the mesh front, and
smooth the mesh front.

51. The software of claim 50 wherein the computer code that is functional to map the mesh front onto the model geometry is further functional to project mesh vertices directly onto the geometry.

52. The software of claim 51 wherein the computer code that is functional to optimize the mesh front is further functional to smooth the vertices and re-project the vertices onto the geometry.

53. The software of claim 51 wherein the computer code that is functional to optimize the mesh front is further functional to combine faces.

54. The software of either claim 41 or claim 51 wherein the computer code that is functional to smooth the mesh front is further functional to perform multiple smoothing passes.

55. The software of claim 54 wherein the computer code that is functional to smooth the mesh front uses a Laplacian smoothing algorithm.

56. The software of claim 55 wherein each smoothing pass comprises projecting each mesh vertex onto the geometry of the model using a closest point projection.
